(19) United States
(12) Patent Application Publication
(10) Pub. No.: US 2013/0339935 A1
(43) Pub. Date: Dec. 19, 2013

(54) Adjusting Programs Online and On-Premise Execution

(71) Applicant: Tamir Melamed, Redmond, WA (US)

(72) Inventor: Tamir Melamed, Redmond, WA (US)

(73) Assignee: MICROSOFT CORPORATION, Redmond, WA (US)

(21) Appl. No.: 13/523,161

(22) Filed: Jun. 14, 2012

(51) Int. Cl. G06F 9/45

(52) U.S. Cl. 717/153

(57) ABSTRACT

The subject disclosure is directed towards a technology by which a program configured as a set of components has its components executed on different nodes of a distributed computer system. A selected node for executing a component is determined by an execution fabric decision mechanism based upon current resource state/capabilities and metadata associated with the component that specifies desired resource-related capabilities for the component. The execution of the component may be moved to a different node to meet the desired resource-related capabilities.

### BACKGROUND

The computing power in the cloud is ordinarily a lot greater than in a user's on-premise machine. However, there are latency, response time, bandwidth, and other limitations that prevent running some programs, including applications and games, in the cloud. For example a first person shooter video game needs a sub-millisecond response time that cannot be achieved via cloud computing.

Some workarounds to this problem include web services, where an application runs on-premise and utilizes the cloud for additional computing and data updates. Another workaround is a web application that runs in browser (e.g., as a thin JavaScript® application) and uses the some of the computing resources of the cloud.

Thus, in contemporary software development scenarios, the developer has to be aware where the developed application will execute. If a developer wants to develop an application that can run both on-premise and as a service, the developer has to write appropriate parts of the application in this way.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an execution fabric runs on a plurality of nodes to execute program code arranged into components. At least some of the components are each associated with a set of metadata. The execution fabric includes a decision mechanism configured to select a selected node for executing a component based upon an evaluation of computing resources associated with at least some of the nodes of the fabric and resource data identified in the set of metadata associated with the component.

In one aspect, there is described executing components of a program configured as a set of components, including dynamically evaluating actual resource capabilities associated with at least some of the nodes of a distributed computing environment. A selected node for executing a component is determined based upon the actual resource capabilities and metadata associated with the component that specifies desired resource-related capabilities for the component. Upon a change in the actual resource capabilities, as detected as part of dynamically evaluating the actual resource capabilities, the execution of the component may be moved to a different node to meet the desired resource-related capabilities.

In one aspect, there is described processing a notation associated with a component, including determining a selected node on which the component is able to run based upon information in the notation and actual state data. The component is executed on the selected node.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a distributed computer system having an execution fabric for executing components on nodes of the fabric, according to one example implementation.

FIG. 2 is a representation of a component and associated metadata (a notation) by which execution/resource requirements and other information is associated with the component, according to one example implementation.

FIG. 3 is a representation of an execution fabric containing remote nodes, one or more local edge nodes, and neighborhood nodes, according to one example implementation.

FIG. 4 is a flow diagram representing example steps that a decision mechanism of an execution fabric may take to select nodes for executing components, according to one example implementation

FIG. 5 is a block diagram representing an example computing environment into which aspects of the subject matter described herein may be incorporated.

### DETAILED DESCRIPTION

Various aspects of the technology described herein are generally directed towards a mechanism for developers and administrators to design, develop, test, and manage programs (including applications and games) without a need to commit where the programs are run and/or how they are executed. To this end, a developer associates metadata (e.g., in XML) with component parts of a program, and an execution fabric uses the metadata in real time to decide an optimized execution location per component or sub-component at a given time. Via the metadata, developers can provide (decorate) hints regarding the suggested execution location.

In one aspect, the distribution of the execution of each component is based on a decision mechanism/algorithm that considers resources including the abilities of edge machines, network utilization, server capacity, execution proximity, latency, component decorations regarding optimized execution, and the like. Execution location may be dynamically adjusted based on a decision algorithm that includes changes on the utilization of the edge machine, network availability and fluctuations, server capacity, routing optimizations, and the like. An optimized default decoration for a component may be suggested based on real time runtime results.

The technology further provides for isolation of components executing on the same machine, enables grouping of components, and/or facilitates defining an isolation level between components and groups of components. An execution grid with a charge back model may be provided, whereby edge machines with spare cycles area able to receive revenue back from the grid. A marketplace lets machine owners suggest a price for their execution engines, with the price taken into account as part of the dynamically adjusting execution decision algorithm.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and software programming in general.

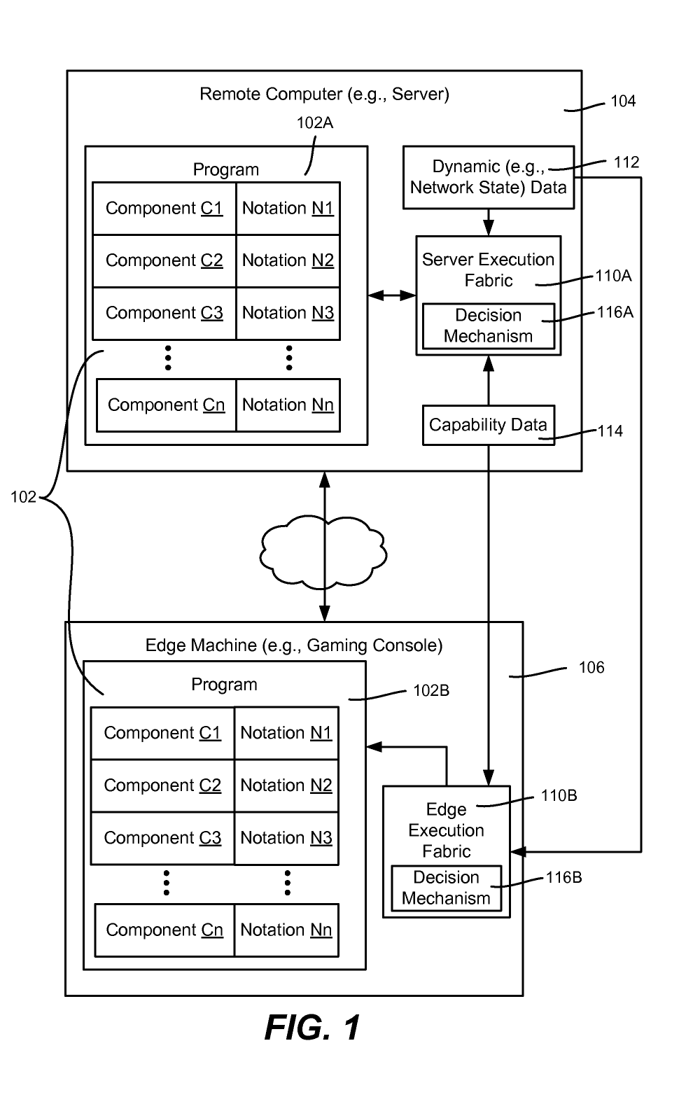

FIG. 1 shows a block diagram comprising an example implementation in which a program 102 comprising instances 102A and 102B is written to run on an execution fabric implemented on a plurality of nodes. In FIG. 1, the illustrated fabric runs on a remote computer 104 such as a server (or set of multiple remote servers computer) and an edge machine 106. The program 102 may comprise any code, including an application, a game, an operating system component, a service, middleware, and so forth. As will be understood, the program 102 may be developed without the developer having to separately develop parts (referred to herein as components) for the remote computer or computers and each such device, and without deciding in advance where the components need to run.

As represented in FIG. 1, the program instances 102A and 102B are configured (e.g., developed and compiled or arranged for execution) as a set of components C1-Cn. As described herein, based upon which components are able to or need to execute on which machine, the instances 102A and 102B may be identical to one another (as exemplified in FIG. 1), one may be a full instance and the other a subset thereof, or each may be non-identical subsets that together comprise the larger full instance program 102. For example, a component that needs more computing power than can be provided by a local device (the edge machine 106) need not be copied to the edge machine 106.

In general, during development, a program to be run on the fabric is broken down to the smallest possible executing logical components. The components (e.g., C1-Cn) may each include associated metadata, referred to herein as notations (e.g., N1-Nn) that declare the behavior of the component such as with respect to resource needs and/or its relationship to other components. Note that a component need not have an associated notation.

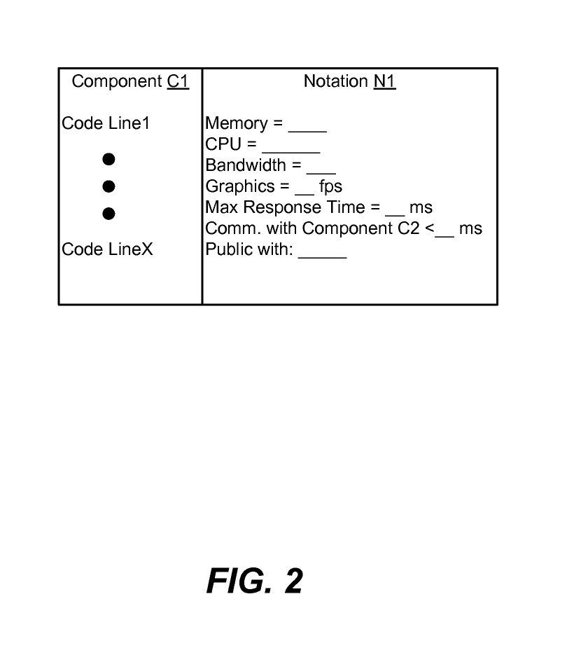

By way of example, FIG. 2 illustrates some of the resources (specified needs) that a notation N1 may specify for is associated component C1. For example, memory, CPU type and availability, instructions per second, memory, I/O (input/output), network availability, network utilization, bandwidth, rendering frames per second, response time and so forth are some of the resources that may be specified in a notation. Not all resources need be specified in each notation, only those that the developer sets forth as being needed for a given component. A notation also may specify resources or the like with respect to a relationship/interaction with another component, e.g., in FIG. 2, the notation N1 specifies that the component C1 needs to be able to communicate with the component C2 in less than some specified number of milliseconds, e.g., 15 ms). More complex notations than those exemplified in FIG. 2 may be used, e.g., to specify “OR” relationships, if-then scenarios, and so forth.

An execution fabric (e.g., layer, blocks 110A and 114, collectively 114) runs on each of the executing end points (servers, phones, game consoles, PC, tablets, and so forth). Each of the developed components C1-Cn may be associated with a notation N1-Nn, respectively, that specifies where that component can run and what are the options/needs for running that component. The notations may identify other components that the specific component needs to communicate with, what is the maximum allowed latency for those other components, and so forth.

In one implementation, the execution fabric 114 is “aware” of the environment, network connectivity, servers' capabilities, edge machine capabilities (network utilization, CPU, memory, GPU) and so forth. The dynamic data such as network data (latency, bandwidth and so forth) that can change due to current conditions is represented in FIG. 1 via block 112, and the (generally static) capability data via block 114. The dynamic data is regularly measured by the execution fabric 110.

The execution fabric 110 processes the notations and data points in real time, and includes a decision mechanism 116A and 116B (collectively 116) that adjusts the component execution location (the node, or possibly nodes where the component is executed) based on the actual status of the edge machine 106 and server 104 (or servers). For example, a component such as C1 may start running on the server 104 for its first execution cycle, and the fabric 110 may activate an instance of the component C1 on the edge machine 106 for a future execution cycle, provided that the network between the edge machine 106 and the server 104 meet the criteria specified in the notation N1 and the component's notation N1 otherwise allows that move. A component instance such as C2 may execute on both the edge machine 106 and the server 104, with the first to finish served as the result of the component's execution. This may help define an optimized execution path for components, e.g., as an A/B test.

By way of a more specific example, consider a video game in which thousands of participants may play at the same time. The components may be written such that the “world” and the interaction between players runs on the server, with the local rendering and collection of each player's interactive data performed on each individual player's machine. The execution fabric 110 may start the game on a local machine and move those components that deal with the player's computations regarding interactions with other players and the “world” to a server.

Turning to another aspect, the execution fabric 110 supports isolation of components using isolation relationship definitions in the component metadata. For example, during runtime, each executing node may run components from one or more programs while providing isolation based on the program definition. In order for a program to be able to access another program, the fabric enables checking the scope of the components that the other program is requesting, and if it is approved, the fabric allows the connection.

Thus, a program may define the isolation scope of its components in the associated notation. By default, components are only open internally, i.e. to other components from that program. Via metadata, a program may make some or all of its components public (e.g., via notation metadata as in FIG. 2), which allows components from other programs to access that component, or a program's component metadata may define a list of allowed programs, a group of programs, components, or group of components to access its components. Instead of having each notation have to repeat the same list or group, for example, global mechanisms may be used to apply such scoping definitions to all components except any specifically excluded.

In another aspect, the execution fabric tracks where each component runs, and thereby provides the basis for a charge model, in which an executing machine can get credit for executing other program components. For example, a set of machines form a fabric grid, whereby a participating user's machine is able to obtain credit (e.g., monetary credit, game points and so forth) via a charge back model. For example, an executing machine that has spare capacity may become a revenue stream for its owner.

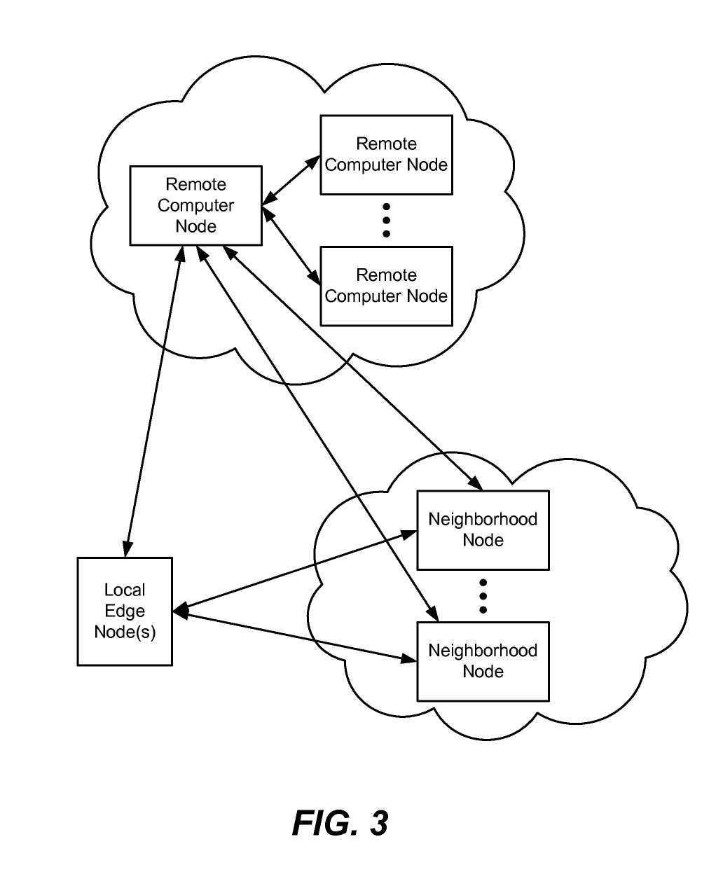

FIG. 3 exemplifies this concept, in which the execution fabric may move components around a grid of nodes, including for credit. One additional concept represented in FIG. 3 is that the grid may include one or more local edge nodes (e.g., a user's home network), and non-local nodes that are remote nodes and neighborhood nodes, such as based on latency, e.g., a close-by node distance-wise may have far less latency than a remote node in the cloud.

As can be readily appreciated, the technology facilitates a marketplace for using spare capacity. For example, machine owners may offer a price for using their execution engines, and others that want the capacity may specify an amount they are willing to pay. This may be taken into account as part of the dynamically adjust execution decision algorithm. Bidding, variable pricing (e.g., a lower price during the day when the owner is at work versus at home using a gaming console, and other such schemes may be implemented.

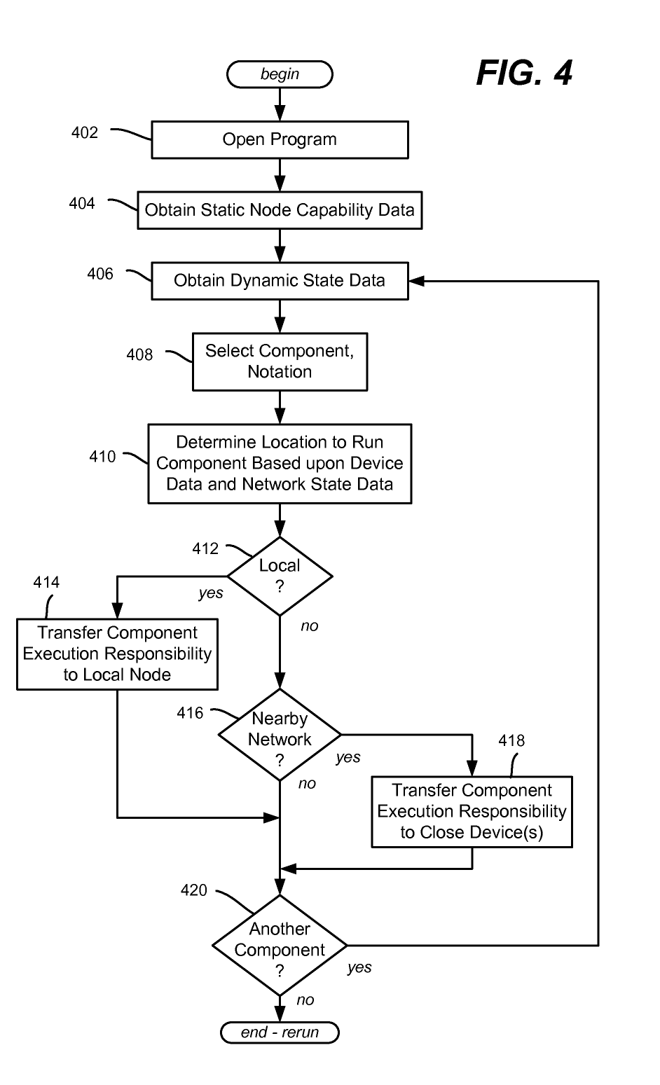

FIG. 4 is a simplified flow diagram showing example steps that a decision mechanism of the execution fabric may take to move (or not move) components among nodes. At step 402, the fabric opens a program. Step 404 represents determining the static capability data of the various nodes on which the components may possible run, and step 406 represents obtaining the dynamic state data. As described herein, dynamic state data may include current network state data, as well as per-node information such as the currently available memory of each node, and so forth.

At step 408, the fabric selects a component, and at step 410 processes the selected component's associated notation (if any) to determine on which node the component can run or needs to run. The fabric (e.g., on the server or a local node, depending where the running was requested) may begin running the program starting from the first component at this time, if desired. However, because of interdependencies that may exist between components, the execution fabric may first process each notation in a first pass (before anything is run) to determine initial execution locations for each component.

As represented via steps 412 and 414, the execution fabric may favor the local node when possible, to facilitate distributed computing, which is low cost, keeps other (e.g., cloud) resources free, and so forth. If the local node is not able to run the component, e.g., the local node is a smartphone with insufficient computing resources, the execution fabric does not choose the local node. Similarly, if the component can otherwise run on the local node except that it has an interdependency with another component that cannot, and too fast of a maximum response time is specified, the execution fabric does not choose the local node. Note that user preference information and other data may also be accessed by the execution fabric, e.g., a user that does not have an unlimited data plan may specify that a local node is not to receive more than X gigabytes of data over a 3G or 4G connection per month even if a component may otherwise successfully run on the local node.

If the execution fabric cannot move the selected component to the local node, steps 416 and 418 represent attempting to transfer the component's execution responsibility to a nearby neighborhood node. Again, this may not be possible if a user specifies a cost limitation that cannot be met by a neighborhood node, or if no neighborhood nodes can meet the notation's requirements. If not able to run on the local node or a neighborhood, then the cloud runs the component. If should be noted that best efforts are used in the event a notation's requirements are not able to be met at any node, e.g., due to current network conditions being inadequate.

Step 420 represents repeating the process for other components, at which time the node for each component is known and the program components execute accordingly. The components need not be processed in order, e.g., if the component N1 has a relationship with the component N22, the component N22 may be processed next to make the execution location decision. Further, note that at least some of these steps may be run in parallel.

At any time, including continuously, periodically or on an event such as a significant change in network state or other dynamic data, including availability of new node or a node leaving the grid, the process may be rerun. In this way, a component may move among the nodes as decided by the fabric, subject to the component's notation and possibly other data (such as preference data, cost data and so forth).

### Example Operating Environment

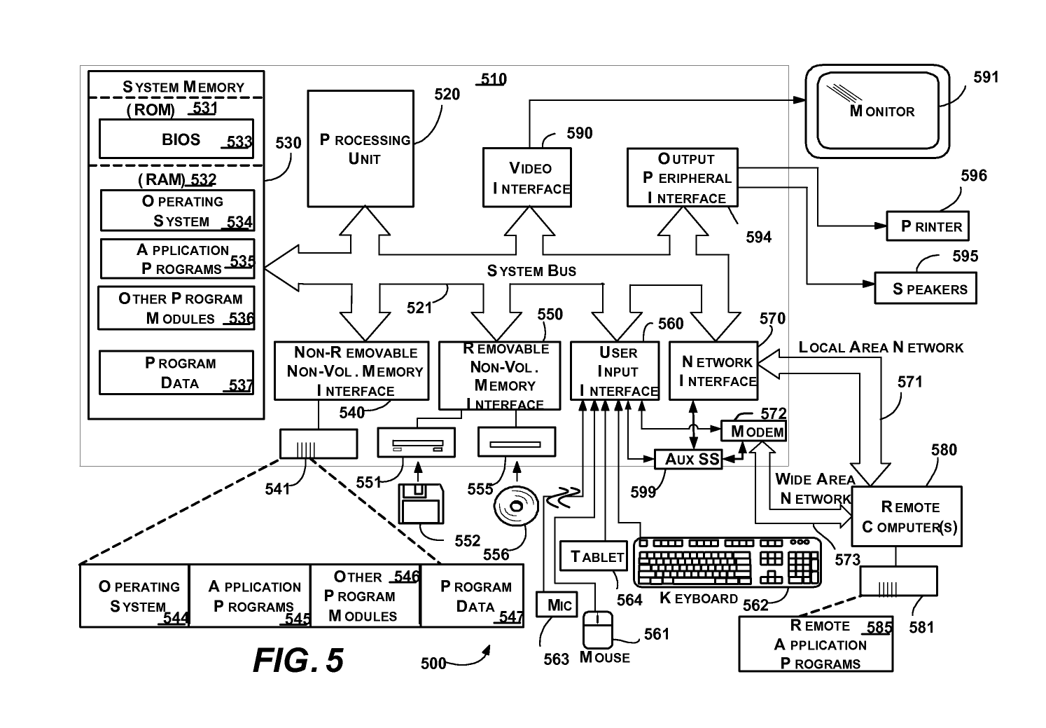

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising, an execution fabric configured to run on a plurality of nodes, the execution fabric configured to execute program code arranged into components, at least some of the components each associated with a set of metadata, the execution fabric including a decision mechanism configured to select a selected node for executing a component based upon an evaluation of computing resources associated with at least some of the nodes of the fabric and resource data identified in the set of metadata associated with the component.

2. The system of claim 1 wherein the resource data identified in the set of metadata specifies a desired CPU-processing power-related capability or a desired memory-related capability, or both.

3. The system of claim 1 wherein the resource data identified in the set of metadata specifies a desired node capacity, execution proximity, latency, or optimized execution, or any combination of node capacity, execution proximity, latency, or optimized execution.

4. The system of claim 1 wherein the resource data identified in the set of metadata specifies a desired network availability-related capability, a desired network utilization-related capability, or a desired network bandwidth-related capability, or any combination of a desired network availability-related capability, a desired network utilization-related capability, or a desired network bandwidth-related capability.

5. The system of claim 1 wherein the resource data identified in the set of metadata specifies a desired I/O-related capability.

6. The system of claim 1 wherein the resource data identified in the set of metadata specifies a desired timing-related capability.

7. The system of claim 1 wherein the resource data identified in the set of metadata specifies a desired video-related capability.

8. The system of claim 1 wherein the set of metadata comprises an XML-based annotation.

9. The system of claim 1 wherein the set of metadata further includes a suggested execution location, and wherein the decision mechanism is further configured to select the selected node based at least in part on the suggested execution location.

10. The system of claim 1 wherein the mechanism is further configured to select a different selected node for executing the component based upon a dynamic evaluation of the computing resources.

11. In a distributed computing environment, a method comprising, executing components of a program configured as a set of components, including dynamically evaluating actual resource capabilities associated with at least some of the nodes of the distributed computing environment, determining a selected node in the computing environment for executing a component based upon the actual resource capabilities and metadata associated with the component that specifies desired resource-related capabilities for the component, and moving the execution of the component to a different node to meet the desired resource-related capabilities upon a change in the actual resource capabilities as detected as part of dynamically evaluating the actual resource capabilities.

12. The method of claim 11 wherein determining the selected node further comprises basing node selection at least in part upon a suggested optimized location for a component determined from real time runtime results.

13. The method of claim 11 further comprising, isolating the selected component from another component executing on the same node.

14. The method of claim 11 further comprising, providing an isolation level specified for at least some of the components, or for at least some defined groups of components, or both for at least some of the components and for at least some defined groups of components.

15. The method of claim 11 further comprising selecting as the selected node an edge node on an execution grid having available resources, and compensating for use of the edge node.

16. The method of claim 15 wherein selecting as the selected node the edge node is based at least in part upon evaluating a price for selecting the edge node.

17. One or more computer-readable media having computer-executable instructions, which when executed perform steps, comprising, processing a notation associated with a component, including determining a selected node on which the component is able to run based upon information in the notation and actual state data, and executing the component on the selected node.

18. The one or more computer-readable media of claim 17 having further computer-executable instructions, comprising, monitoring the actual state data, processing the notation to determine whether the component remains able to run on the selected node in view of possible changes to the actual state data, and if not, selecting a new node for running the component and transferring execution responsibility of the component to the new node.

19. The one or more computer-readable media of claim 17 wherein determining the selected node comprises evaluating capabilities of an edge node as part of the actual state data.

20. The one or more computer-readable media of claim 17 wherein determining the selected node comprises evaluating interdependency data between the component and at least one other component.
